(19) United States
(12) Patent Application Publication
(10) Pub. No.: US 2013/0319231 A1
(43) Pub. Date: Dec. 5, 2013

(54) INTEGRATED SYSTEM FOR ACID GAS REMOVAL

(71) Applicants: Aqil Jamal, Richmond, TX (US); Raghubir P. Gupta, Durham, NC (US); Lora Toy, Morrisville, NC (US); Luke Coleman, Durham, NC (US)

(72) Inventors: Aqil Jamal, Richmond, TX (US); Raghubir P. Gupta, Durham, NC (US); Lora Toy, Morrisville, NC (US); Luke Coleman, Durham, NC (US)

(73) Assignee: RESEARCH TRIANGLE INSTITUTE, Research Triangle PArk, NC (US)

(21) Appl. No.: 13/992,089

(22) PCT Filed: Dec. 7, 2011
(86) PCT No.: PCT/US11/63777

§ 371 Date: Aug. 16, 2013

Related U.S. Application Data
(60) Provisional application No. 61/421,320, filed on Dec. 9, 2010.

(51) Int. Cl. B01D 53/22

(52) U.S. Cl. CPC B01D 53/229
USPC 95/51; 96/4; 95/45

(57) ABSTRACT

The invention relates to a system for the removal of acid gases from gas streams. The system comprises an integrated membrane-based and liquid solvent-based system for the capture of acid gases. The invention also relates to methods of acid gas capture from gas streams.

### FIELD OF THE INVENTION

The present invention relates to systems for the removal of acid gases (e.g., CO₂) from gas streams such as flue gas streams. More specifically, the invention provides for the integration of solvent-based acid gas removal technologies with membrane-based acid gas removal technologies to create a hybridized and/or improved acid gas removal process.

### BACKGROUND OF THE INVENTION

It is widely accepted that rising levels of greenhouse gases are contributing to changes in the world's climate. The most prominent greenhouse gas in our atmosphere is carbon dioxide. Concentrations of carbon dioxide (CO₂) are estimated to have increased approximately 36% since pre-industrial times according to the National Oceanic and Atmospheric Administration. This increase is due to the fact that much of the carbon dioxide in our atmosphere arises from the burning of fossil fuels (i.e., coal, oil, and natural gas) for power generation. The United States meets approximately 85% of its energy needs through burning fossil fuels. For example, in 2007, coal-fired power plants emitted about 81% of the carbon dioxide produced from electrical power generation and 36% of total carbon dioxide emissions. According to the U.S. Energy Information Administration's 2009 Annual Energy Outlook, carbon dioxide emissions from coal-fired power plants are expected to increase by at least 16% by 2030.

Because fossil fuels, particularly coal, will continue to be used for producing power in the near- and long-term, efforts are underway to develop CO₂ emissions control technologies to aid in greenhouse gas mitigation. Ideally, such carbon capture technologies would not require modification of major power plant infrastructures such as fuel processing, boiler, and steam turbine sub-systems, and could be integrated into existing gas cleanup systems in such a way as to simplify the retrofit process. The removal of CO₂ from process gas streams has been carried out industrially for over a hundred years, but none of these processes have been used on a scale as large as that required by industrial power plants.

Amine-based solvent scrubbing is the only process technology currently available at a scale approaching the scale needed for flue gas CO₂ capture from power plants. However, a high parasitic energy load is associated with the use of solvent scrubbing processes, as the scrubbing solvent must be regenerated, which typically requires considerable energy input. Membrane-based gas separation technology may overcome the regeneration energy penalty noted above for solvent-based processes, but is not as well-established. For flue gas carbon capture applications in power plants, membrane-based CO₂ capture processes also require considerable energy input because flue gas typically needs to be compressed to a high pressure prior to being passed through the membrane. Some technologies combining these two acid gas removal technologies (solvent-based and membrane-based) have previously been developed.

G.B. Patent No. 2449165 describes a method for separating CO₂ from flue gas by providing an absorber unit having a membrane contactor; channeling a combustion flue gas along a first surface of the membrane contactor; and channeling an ammonia-based liquid reagent along a second opposing surface of the membrane contactor. The method also is described as including partially separating the ammonia-based liquid from the flue gas such that the ammonia-based liquid and the flue gas contact at gas-liquid interface areas, defined by a plurality of pores of the membrane contactor, to separate CO₂ from the flue gas by a chemical absorption of CO₂ within the ammonia-based liquid to produce a CO₂-rich ammonia-based liquid.

U.S. Pat. No. 5,749,941 describes a method for the absorption of one or more gaseous components when brought into contact with a liquid phase, where the gas phase and the liquid phase are separated by a hydrophobic porous membrane of a material other than polytetrafluoroethylene, e.g., polypropylene, polyethylene, polyvinylidine fluoride, and polysulfone. The liquid phase is described as comprising water and a water-miscible and/or a water-soluble absorbent and does not give rise to any leakage for the membrane or is effective in preventing or counteracting leakage from the membrane.

U.S. Pat. No. 6,165,253 describes a system for transferring a solute from a feed gas mixture to an absorbent liquid. The system is described as comprising an absorption module, a pressure control means and a regeneration module. The absorption module is further described as containing a porous membrane, wherein the pores of the membrane are wetted by the absorbent liquid contacting the feed gas mixture and the gas-liquid contact at the pore mouth is on the gas side of the fiber. The pressure within the absorption module is described as being controlled so that the interface between the gas feed mixture and the liquid absorbent is substantially immobilized at the membrane to effectively prevent the formation of a dispersion of gas feed mixture and liquid absorbent in either chamber. The regeneration module is described as containing a nonporous material that is selectively permeable to the solute, which divides the regeneration module into a liquid absorbent chamber and a vacuum atmosphere chamber.

U.S. Pat. No. 5,281,254 describes a membrane contactor system for the removal of carbon dioxide and water vapor from a gaseous stream. This membrane contactor system is described as having a first and a second porous membrane with a liquid amine based sorbent on a first side of both the first and second porous membranes, and a means for producing a carbon dioxide partial pressure gradient across the second porous membrane sufficient to induce absorption of carbon dioxide at the first porous membrane, and desorption of the absorbed carbon dioxide. As a result of their porosity, the membranes described allow direct gas-liquid contact while preventing sorbent leakage.

U.S. Pat. No. 5,714,072 describes a method of solvent extraction. The steps of the method are described as including: providing a dual-skinned asymmetric microporous membrane; providing a feed containing a solute; and providing a solvent. The patent describes the method steps as the feed and the solvent being contacted across the membrane and the solute of the feed being extracted, forming thereby a raffinate and an extract.

U.S. Pat. No. 6,228,145 describes a method for removing carbon dioxide from combustion gases and natural gas. The method is described as utilizing membrane gas/liquid contactors both in the absorber and the desorber. The patent describes the method as preferably using solvents with lower mass transfer coefficients due to the membrane gas/liquid contactor's high packing factor.

U.S. Pat. No. 6,585,496 describes a fully perfluorinated thermoplastic hollow fiber membrane fluid-fluid contactor and a process for manufacturing the contactor. The contactor is described as having a unitary end structure produced by a single step potting and bonding process and is further described as capable of being operated with low surface tension liquids and in harsh chemical environments.

U.S. Pat. No. 4,147,754 describes hydrogen sulfide removal from a mixture of gases including carbon dioxide by passing the mixture over an immobilized liquid membrane in intimate contact with a hydrophobic, microporous gas-permeable barrier and absorbing in a liquid solution hydrogen sulfide passing through the membrane. The patent describes a sweep of hot carbonate solution wherein a nearly stagnant boundary layer adjacent to the gas permeable barrier absorbs acid gases by reaction and diffusion, maintaining low hydrogen sulfide partial pressure at the outlet side of the barrier. The patent describes an alternative sweep comprising an aqueous solution containing a redox agent which converts absorbed hydrogen sulfide into sulfur, or an ethanol amine solution. The apparatus is described as exhibiting low permeability to carbon dioxide and high permeability to hydrogen sulfide.

U.S. Patent Application Pub. No. 2002/0053285 describes methods using potassium or other alkali metal formate solution to absorb moisture from gas through a membrane. The membrane is described as being supported on permeable tubes, and the potassium or other alkali metal formate may be regenerated for reuse, preferably by a cavitation regenerator. The process is described as being especially useful for dehydration of natural gas.

U.S. Patent Application Pub. No. 2003/0033932 describes a method for the separation of carbon dioxide from a gas mixture, wherein a dendrimer selective for carbon dioxide is present in an immobilized liquid membrane, the dendrimer being either in pure form or optionally with at least one solvent, the latter also having selective carbon dioxide properties. In another embodiment, the method is described as using a dendrimer selective for carbon dioxide and capable of forming a film as the membrane itself, optionally with at least one solvent.

U.S. Pat. No. 7,273,549 describes an apparatus for modifying the concentration of a predetermined substance present in a first fluid flowing through a conduit having an inner surface, the apparatus including a first hollow fiber membrane module, baffle assembly, and fluid source.

U.S. Pat. No. 5,725,769 describes a microporous membrane formed from a copolyimide. The key advantages of such microporous hollow fiber membranes formed by the process are described as being that one component provides a sufficiently high glass transition temperature to permit retention of the microporous structure of the precursor polyamic acid fiber when converted by heat treatment to the polyimide form; and another component, following post-treatment such as by heat, provides exceptional solvent resistance.

It should be noted that the references discussed above focus on the use of porous, non-selective membranes as the partition between the two different fluid phases. It would be beneficial to develop further acid gas removal technologies including CO₂ capture or removal process technologies that are able to operate under conditions commonly encountered in power plant or industrial flue gas streams and that do not have high parasitic energy loads associated with their use.

### SUMMARY OF THE INVENTION

The invention generally relates to a system for the removal of acid gases from mixed gas streams. In one embodiment, the system comprises an integrated membrane-based and liquid solvent-based system. The system may, in some embodiments, selectively remove carbon dioxide (CO₂) from mixed gas streams. In other embodiments, the system may selectively remove hydrogen sulfide (H₂S) from mixed gas streams.

The integrated system may be described as an integrated system that provides a means of separating acid gases from mixed gas streams by both membrane-based gas permeation and gas-liquid absorption mechanisms in a process system. In preferred embodiments, the inventive integrated system comprises an upstream region wherein membrane-based gas permeation of acid gases is the dominant separation mechanism and a downstream region wherein gas-liquid absorption of acid gases is the dominant separation mechanism. In some embodiments, the upstream region can be the feed gas inlet end of the system. In some embodiments, the downstream region can be the reduced pressure region at the retentate end of the system.

In some embodiments, the integrated system comprises a membrane that is selective for an acid gas and that is structured to have a first side and a second, opposing side. The first side may be in contact with a mixed gas stream and the second, opposing side may be in contact with a liquid-phase solvent selective for acid gases or for one or more specific acid gases of interest. Alternatively, the first side may be in contact with a liquid-phase solvent selective for acid gases or for one or more specific acid gases of interest and the second, opposing side may be in contact with a mixed gas stream. In specific embodiments, the integrated system directs flow of the gas stream and flow of the liquid-phase solvent countercurrently. The membrane may, in some embodiments, be a non-porous, gas-selective membrane of a self-supporting thickness (e.g., comprising a dense, selective polymer skin having a thickness of about 10 to about 70 nm, coated onto or formed on a microporous membrane structure).

In certain embodiments, the integrated system comprises a CO₂-selective membrane having a first or second side in contact with a mixed gas stream and the other of the first and second side in contact with a CO₂-selective solvent. In certain embodiments, the CO₂/N₂ selectivity of the membrane is at least about 10, preferably about 20 to about 30, or more preferably about 50 to about 60. In some embodiments, the CO₂-selective solvent is a liquid solvent with a pH greater than about 6.4. In other embodiments, the integrated system comprises a H₂S-selective membrane having a first or second side in contact with a mixed gas stream and the other of the first and second side in contact with a H₂S-selective solvent.

In another aspect of the invention, the inventive system can be incorporated into a method for removing an acid gas (e.g., CO₂) from a mixed gas stream. In such methods, a mixed gas stream can be brought into contact with an integrated membrane-based and liquid solvent-based system. For example, in some embodiments, the method comprises bringing a mixed gas stream in contact with a first side of a CO₂-selective membrane, wherein the second, opposing side of the membrane is in contact with a liquid-phase CO₂ selective solvent. Alternatively, the first side of the membrane may be in contact with a liquid-phase CO₂ selective solvent and the second, opposing side may be in contact with a mixed gas stream. The method may result in removal of CO₂ from the mixed gas stream via both a gas membrane permeation mechanism and a gas-liquid absorption mechanism. In certain embodiments, a gas membrane permeation mechanism is dominant at the upstream (e.g., feed gas inlet) portion of the system and a liquid absorption mechanism is dominant at the downstream, lower-pressure (e.g., retentate) portion of the system.

### BRIEF DESCRIPTION OF THE DRAWINGS

FIG. 1 is a depiction of a composite membrane contactor of the present invention;

FIG. 2 is a schematic showing the two dominant types of gas separation zones (membrane permeation-dominant and gas-liquid absorption-dominant) in the integrated system disclosed in the present application;

FIG. 3 is a process flow diagram of a generalized solvent-based flue gas scrubbing technology;

FIGS. 4a-4c illustrate the simulated effect of membrane CO₂/N₂ selectivity on permeate CO₂ purity as a function of fractional CO₂ removal for membrane process operating at pressure ratio of (a) 2.5, (b) 17, and (c) 30 (simulation assumptions: membrane CO₂ permeance=1,000 GPU; flue gas flow rate=800,000 acfm);

FIGS. 5a-5c illustrate the simulated effect of CO₂ removal on required membrane area and permeate CO₂ purity for single-stage membrane process operation at pressure ratio of (a) 2.5, (b) 17, and (c) 30 (simulation assumptions: CO₂ permeance=100 GPU; CO₂/N₂ selectivity=35; flue gas flow rate=800,000 acfm);

FIG. 6 is a graph charting the simulated effect of membrane CO₂ flux and pressure ratio on membrane area requirement in m²/ton of CO₂ captured for 90% CO₂ removal by a single-stage membrane unit operation (simulation assumptions: CO₂/N₂ selectivity=35; flue gas flow rate=800,000 acfm); and

FIG. 7 is a process flow schematic of one embodiment of an integrated membrane-based and liquid solvent-based system configuration of the present invention.

### DETAILED DESCRIPTION OF THE INVENTION

The present invention now will be described more fully hereinafter with reference to the accompanying figures, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used in the specification and in the appended claims, the singular forms “a”, “an”, and “the” include plural referents unless the context clearly dictates otherwise. Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

In one embodiment of the present invention is provided a system for the capture of acid gases from a gas stream. For example, in some embodiments, the system may be designed for the capture of carbon dioxide from a gas stream. Of course, the invention is not so limited, and the inventive system could find use in a variety of other technologies, such as processing of natural gas (e.g., to minimize CH₄ loss associated with traditional membrane technology) and process gas sweetening (H₂S acid gas removal).

The system generally comprises two dominant types of gas separation zones (membrane permeation-dominant and gas-liquid absorption-dominant). The inventive system can be particularly beneficial because the integration of membrane and solvent absorption technologies may result in a reduction in the total energy penalty associated with the removal of acid gases from gas streams as compared with current acid gas removal technologies.

For example, although a 2-stage membrane approach for removing CO₂ from mixed gas streams may initially have a low associated energy penalty for low capture levels of CO₂ (e.g., about 2 megajoule thermal per kilogram (MJₜₕ/kg) CO₂ for 10% CO₂ captured), the energy penalty rises considerably as the system is pushed to higher percentage of CO₂ capture (e.g., about 4 MJₜₕ/kg CO₂ at 90% capture). An aqueous monoethanol amine-based process has a higher initial energy penalty of between 3.5 and 4 MJₜₕ/kg CO₂ and decreases slightly to between about 3 and about 3.5 MJₜₕ/kg CO₂ at higher capture levels of 25%-90% CO₂. The energy penalty associated with the integrated system described herein, however, may be less than about 3 MJₜₕ/kg CO₂ even at 90% CO₂ capture.

The inventive integrated system described herein takes advantage of the observation that there are regions of operation wherein each of the respective technologies (i.e., solvent absorption and membrane permeation) operates most efficiently. Based on this understanding, the operating parameters may be adjusted accordingly to exploit the benefits of each technology. More specifically, the inventive integrated system takes advantage of the transmembrane pressure driving force enhancement and lower solvent requirement of combining the two technologies. This combination of gas separation principles results in a reduction of the energy required to achieve effective CO₂ removal.

For example, the integrated system may be configured such that it operates as a gas-permeation membrane when the carbon dioxide partial pressure is sufficiently high (e.g., near the upstream feed inlet end portion), and as a gas-liquid absorption system when the carbon dioxide partial pressure of the gas is sufficiently low (e.g., near the downstream, lower-pressure retentate end portion). The integrated system may result in an energy penalty of less than, for example, about 10 MJₜₕ/kg, less than about 5 MJₜₕ/kg, less than about 4 MJₜₕ/kg, less than about 3 MJₜₕ/kg, less than about 2 MJₜₕ/kg, or less than about 1 MJₜₕ/kg of carbon dioxide removed. In certain embodiments, these energy penalties are achievable at high capture levels of CO₂ (i.e., at about 50%, about 60%, about 70%, about 80%, and about 90%). For example, in one embodiment, the use of an integrated system according to the present invention with activated MDEA as the solvent reduced the energy penalty to about 1.86 MJₜₕ/kg (800 British Thermal Units per pound (Btu/lb)) of carbon dioxide captured.

In certain embodiments, the solvent used for gas-liquid absorption according to the present invention may be any acid gas-selective solvent (e.g., any CO₂-selective solvent). By “CO₂-selective solvent” is meant any solvent that interacts with CO₂ (e.g., by chemical reaction, chemical or physical absorption) in a manner that CO₂ is preferentially, with respect to the other components of the mixed gas stream, taken up by the liquid phase. In certain embodiments, the selectivity is defined in terms of the number of moles of CO₂ gas taken up by the solvent per moles of other gas taken up by the solvent. In some embodiments, this selectivity can be, for example, at least about 1, at least about 5, at least about 10, at least about 15, at least about 20, at least about 25, or at least about 50.

The solvent may solubilize CO₂ by any means, e.g., the CO₂ may be soluble in the solvent or the CO₂ may react with a dissolved species or the solvent itself to form a soluble species. The solvent may be miscible or immiscible with water. In some embodiments, the CO₂-selective solvent is any solvent that reacts with CO₂ to form carbamate, carbonate, and/or bicarbonate salts in solution. In some embodiments, the solvent has a pH of greater than about 6.4, greater than about 7, greater than about 8, greater than about 9, greater than about 10, greater than about 11, greater than about 12, or greater than about 13. Non-limiting examples of some types of solvents that are encompassed within the present invention include solutions comprising one or more of amines (including alkanolamines), amino acid salts, organic carbonates, alkali hydroxides and carbonates, and ionic liquids. Because the integrated system may be designed such that oxygen that may be in the mixed gas stream does not come in contact with the liquid solvent, solvents that typically degrade in and thus cannot be used in oxygen-containing gas streams can be used in certain embodiments of the present invention. Mixtures of solvents may also be used according to the present invention.

In some specific embodiments, the solvent comprises activated N-methyl diethanol amine (MDEA), an aqueous monoethanolamine (MEA) or diethanolamine (DEA) solution, or a solution of 1,8-diazabicycloundec-7-ene (DBU) and methanol. Numerous solvents that may be utilized in the integrated system of the present invention are commercially available. For example, MEA-based solvents (ECONAMINE™ FG and ECONAMINE™ FG+) are available from Fluor Corporation, a hindered amine-based solvent is available from Mitsubishi Heavy Industries/Kansai Electric Power Company (KM-CDR Process®), an ammonia-based solvent is available from Alstom Power, Inc. (Chilled Ammonia Process), an amine-based solvent is available from Dow Chemical (Advanced Amine Process), an amino acid salt-based solvent is available from Siemens Energy (proprietary solvent), and an ammonia-based solvent is available from Powerspan (ECO2®).

The membrane may be any type of membrane through which the acid gas to be removed from the gas stream can permeate. Preferably, the membrane is nonporous. In certain embodiments, the membrane is selective for the acid gas to be removed from the gas stream (e.g., a CO₂-selective membrane). For example, a CO₂-selective membrane preferentially transports CO₂ through the membrane in the presence of other gases (e.g., N₂, CH₄) in the process stream to produce a CO₂-enriched permeate and a CO₂-depleted retentate. This preferential permeation of CO₂ over other gas species is characterized as a membrane selectivity greater than unity. The membrane selectivity may, in certain embodiments, afford an increase in speed with which the desired gas (e.g., CO₂) is transported through the membrane as compared with the speed with which other gases are transported through the membrane.

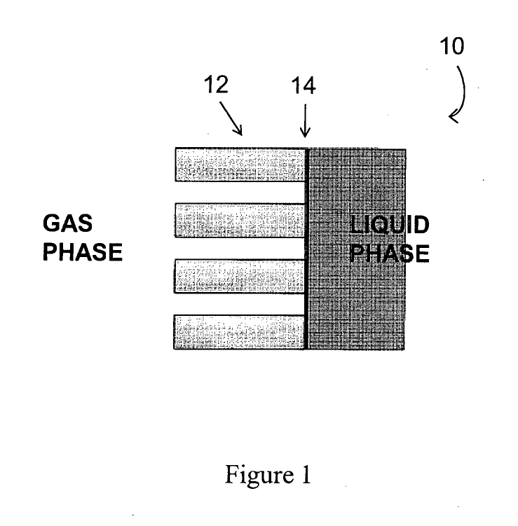

The membrane may have any type of structure (morphology). For example, in some embodiments, the membrane may be a dense-film membrane, an asymmetric membrane (e.g., an asymmetrically integrally skinned membrane), or a composite membrane. In some embodiments, the system may comprise a composite membrane with an ultrathin, nonporous, gas-selective layer. For example, in FIG. 1, a system 10 is shown wherein the membrane comprises a dense polymer skin (i.e., a thin top layer 14) coated on a microporous membrane structure 12. In certain embodiments, the polymer skin may have a thickness of up to about 1,000 nm, preferably between about 10 and about 500 nm, and most preferably between about 10 nm and about 70 nm.

The membrane may comprise any type of material suitable for CO₂ transfer. In certain embodiments, the membrane may comprise a material that allows carbon dioxide to permeate (or be transported) across the membrane at a sufficient rate for absorption by a solvent on the permeate side. For example, the membrane may comprise a polymer, such as polycarbonate, polybenzimidazole, polysulfone, polydimethylsiloxane, a polyether block amide (e.g., PEBAX®), polyethersulfone, polyimide (e.g., KAPTON® PI), or polyvinylidene fluoride. Ideally, the membrane and solvent must be selected such that they are compatible, that is, the membrane comprises a material that is chemically and mechanically stable in the solvent selected. One of skill in the art would readily be able to determine the compatibility of various membrane materials with various solvents to select a workable combination.

There are numerous design considerations that may be taken into account with regard to the selection of a membrane. See, for examples, the discussion in Dortmundt & Doshi (UOP, LLC), Recent Developments in CO₂ Removal Membrane Technology (1999), incorporated herein by reference. For example, the membrane may be any size suitable for the desired application. In some embodiments, the membrane area is minimized to keep membrane costs economical. The size of the membrane required for a given separation is a function of membrane selectivity and pressure ratio (a measure of pressure driving force defined as p_{feed}/pₚₑᵣₘₑₐₜₑ). Therefore, in some embodiments, the membrane is selected such that membrane selectivity for carbon dioxide is high and the pressure ratio is also high.

In some embodiments, the membrane allows for at least partially selective permeation of carbon dioxide. In some embodiments, the membrane selectivity is high. The ability of a membrane material to separate two components, A and B, is often characterized in terms of the ideal selectivity, α_{A/B}, which is defined as the ratio of their permeabilities.

$${α}_{A / B} = \frac{{P}_{A}}{{P}_{B}} = [ \frac{{D}_{A}}{{D}_{B}} ] [ \frac{{S}_{A}}{{S}_{B}} ]$$

In some embodiments, the membrane is selective for carbon dioxide over nitrogen. In some embodiments, the membrane has a carbon dioxide/nitrogen selectivity of at least about 10, of at least about 15, of at least about 20, of at least about 25, or of at least about 50. In some embodiments, the membrane has a carbon dioxide/nitrogen selectivity in the range of about 20 to about 30. In some embodiments, the membrane has a carbon dioxide/nitrogen selectivity in the range of about 50 to about 60.

As indicated above, selection of the membrane for use in the system described herein may also be impacted by pressure ratio. This is due to the fact that the process of carbon dioxide permeation through the membrane is limited by the carbon dioxide feed concentration and the pressure ratio across the membrane. In some embodiments, the membrane functions under an imposed partial pressure gradient by creating a permeate stream that is enriched in carbon dioxide, and a retentate stream depleted in carbon dioxide. The flux of gas A through a membrane can be written as:

$${N}_{A} = \frac{{P}_{A} Δ p}{l} = \frac{{P}_{A} ( {p}_{2} - {p}_{1} )}{l}$$

wherein P_{A} is the permeability of gas A in the membrane [cm³(STP)·cm/(cm²·s·cmHg)], l is the membrane thickness (cm), and p₂ and p₁ are the feed (upstream) pressure and permeate (downstream) pressure (cmHg), respectively, of gas A. The pressure-normalized flux is commonly expressed in units of GPU where 1 GPU=10⁻⁶ cm³(STP)/(cm²·s·cmHg).

In some embodiments, the membrane is relatively impermeable to oxygen. In such embodiments, any solvent degradation due to oxygen may be decreased and/or avoided. Therefore, in these embodiments, solvents as mentioned above that cannot operate in oxygen-containing gas streams due to rapid degradation in the presence of oxygen can be used. For example, in system embodiments wherein the membrane is impermeable to oxygen, single component amine-based solvent systems may be used.

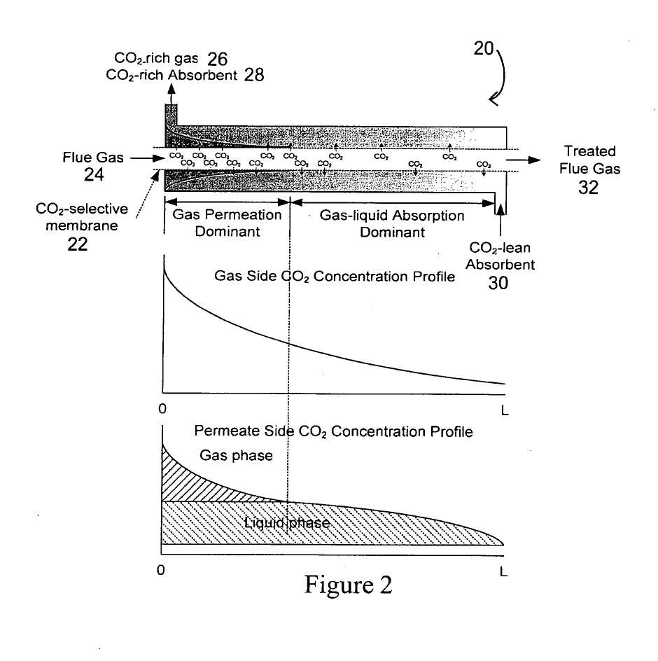

The inventive integrated system may be configured in any of a number of ways. FIG. 2 illustrates an exemplary schematic of one embodiment of a system 20 according to the present invention. As shown, a gas stream 24 comprising CO₂ (e.g., post-combustion flue gas) enters the system. In some embodiments, the gas stream is first compressed. For example, the gas stream may be compressed to a pressure greater than atmospheric pressure. In specific embodiments, the pressure may be about 15 psig to about 70 psig, more preferably about 18 psig to about 50 psig.

Upon entering the system, the gas stream is brought into contact with a first side of a CO₂-selective membrane 22. In the illustrated system, the CO₂-selective membrane defines a passage of determined length through which the gas stream passes. The length of the membrane may vary. For example, the length of the membrane may be from about 1 cm to about 10 m or from about 10 cm to about 10 m. In some preferred embodiments, the membrane has a length of about 1 m. In certain embodiments, the membrane may comprise multiple modules by connecting them in series or in parallel. For example, multiple membrane modules with lengths of about 1 m may be connected to form a membrane of the desired length.

The second, opposing side of the CO₂-selective membrane is in contact with a CO₂-selective liquid-phase solvent. In some preferred embodiments, the gas stream and the liquid-phase solvent flow counter-currently. As illustrated, the integrated system can be described as comprising two regions, i.e., a gas permeation-dominant region, wherein CO₂ permeates through a membrane into a liquid-phase, CO₂-rich solvent stream due to a high CO₂ partial pressure gradient and a gas-liquid-absorption-dominant region, wherein CO₂-lean solvent draws CO₂ through the membrane to overcome a reduced feed-side CO₂ partial pressure.

According to this type of setup, in preferred embodiments, the gas-permeation dominant region comprises the upstream portion of the membrane proximal to the entry of the gas into the passage and the gas-liquid-absorption dominant region comprises the downstream portion of the membrane distal to the entry of the gas into the passage. In such embodiments, as the CO₂-containing gas enters the system, CO₂ rapidly diffuses through the membrane, forming a CO₂-rich gas phase on the permeate side, which exits the systems with the liquid phase, CO₂-rich solvent. As the gas continues to flow down the membrane, CO₂ continues to permeate and the CO₂ partial pressure in the gas becomes too low to facilitate transport through the membrane. At this point, the gas enters the gas-liquid absorption dominant region. In this region, the CO₂ partial pressure gradient across the membrane is increased by the presence of a reactive, liquid phase carbon dioxide solvent that removes CO₂ from the liquid-membrane interface. Treated gas 32 exits the system. A CO₂-rich gas 26 and a CO₂-rich solvent 28 two-phase stream exits the system and separates. In some embodiments, the liquid-phase, CO₂-rich solvent may then be regenerated to release a CO₂ product and a CO₂-lean solvent 30 that, in certain cases, may be recycled to the system.

In some embodiments, this reaction of CO₂-lean solvent with permeated CO₂ can be described as improving the partial pressure gradient. For example, there may be only a small variation in the partial pressure gradient of CO₂ across the membrane along the length of the membrane, even though the natural partial pressure gradient in relation to CO₂ would be expected to decrease along the length of the membrane as the CO₂ moves out of the gas stream and across the membrane. In the present invention, the effect of the CO₂-lean solvent in drawing CO₂ through the membrane may overcome this expected reduction in partial pressure to some extent. Accordingly, the invention advantageously increases the mass transfer driving force across the membrane, allowing more CO₂ to diffuse through the membrane.

Numerous other setups are applicable in the context of the present invention. For example, in certain embodiments, the system may comprise a hollow fiber contactor with shell-side solvent and tube-side gas or vice versa. In other embodiments, the system may comprise a plate-and-frame contactor, a tubular contactor, or a spiral wound contactor. Key parameters that may be adjusted to optimize the inventive integrated system described herein include membrane material, membrane module cost, solvent selection, heat integration, and/or hybrid process design.

In preferred embodiments, the method described herein can achieve a high removal percentage of carbon dioxide from the gas stream. The gas stream may be any stream containing CO₂. For example, the gas stream may be a flue gas stream. In some embodiments, the method can achieve greater than about 80% capture of CO₂, greater than about 85% capture of CO₂, greater than about 90% capture of CO₂, or greater than about 95% removal of CO₂ from the CO₂-containing gas stream. In certain embodiments, CO₂ can diffuse across the membrane with little to no impact on the rate of CO₂ loading into the solvent.

In some embodiments, the integrated system may be encompassed within a large-scale gas purification system. For example, it may be encompassed within a post-combustion flue gas cleanup system, such as those required by power plants. The overall system may comprise numerous additional elements, including, but not limited to, fuel processing, boiler, and steam-turbine sub-units and flue gas desulfurization units, as well as any additional elements that one of skill would recognize as useful in light of the present disclosure. In some embodiments, before entering the system of the present invention, the CO₂-containing gas stream may be subjected to pretreatment. For example, the flue gas may be pretreated by one or more of SO₂ and HCl polishing, ash removal, dehydration, and cooling. In certain embodiments, the integrated system may be retrofitted to existing gas purification systems.

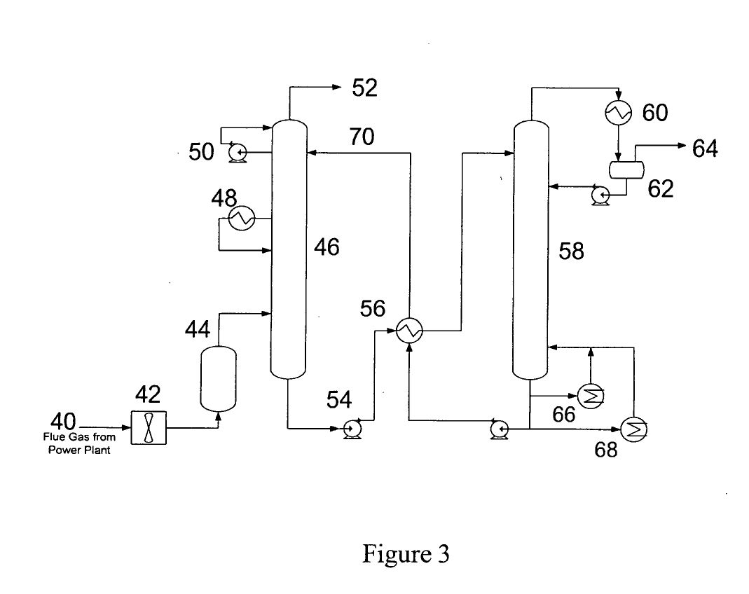

FIG. 3 shows a schematic diagram of a gas purification system for the removal of CO₂ from a gas stream 40. The illustrated system is used herein as an example for discussion and should not be construed as necessarily limiting of the invention. In this particular embodiment, the gas passes through a blower 42, passes through a pre-treatment region 44, and into an absorber 46. The absorber may be equipped with an interstage cooler 48 and a wash system 50. CO₂-lean flue gas 52 and CO₂-rich solution 54 are produced; the CO₂-lean gas is released from the system and the CO₂-rich solution is passed through a crossover exchanger 56 into a stripper 58. Features of the stripper include a condenser 60 and a water knockout drum 62, which generate purified CO₂ 64, which can be removed from the system as well as a reboiler 66 and reclaimer 68. CO₂ lean solvent 70 is recycled back to the exchanger 56 and directed back into the absorber 46. The specific components of the cycle may be varied, as is described in more detail in Example 4 provided below. The integrated membrane-based and liquid solvent-based system disclosed herein may readily be incorporated within any such a gas purification system for the removal of CO₂ or other acid gases according to the present invention.

### EXAMPLES

### Example 1

### Effect of Membrane Selectivity on Permeate CO₂ Purity as a Function of Fractional CO₂ Removal

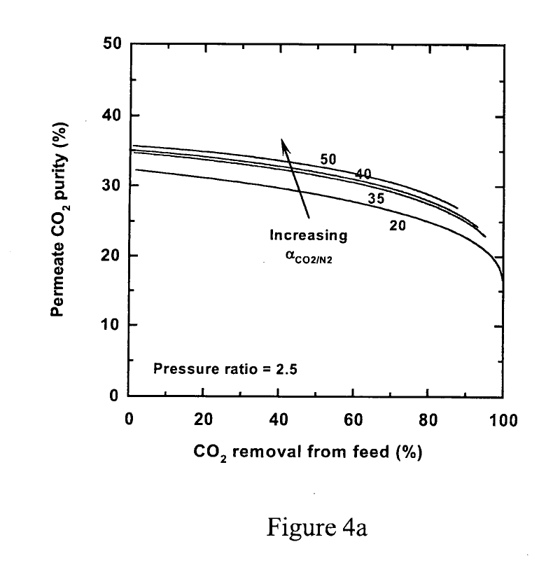

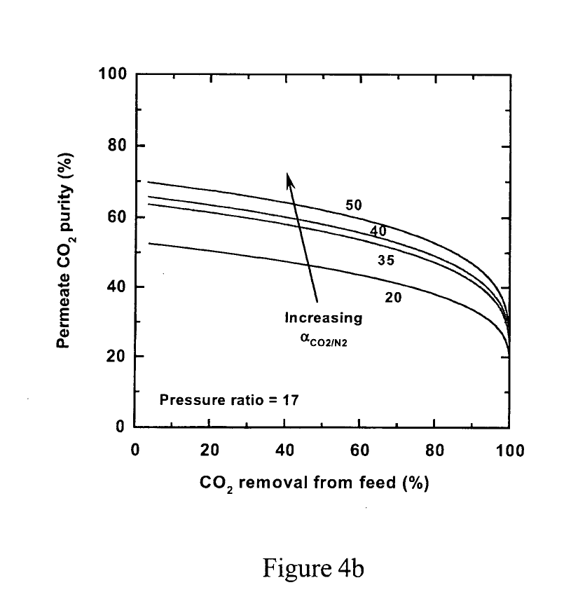

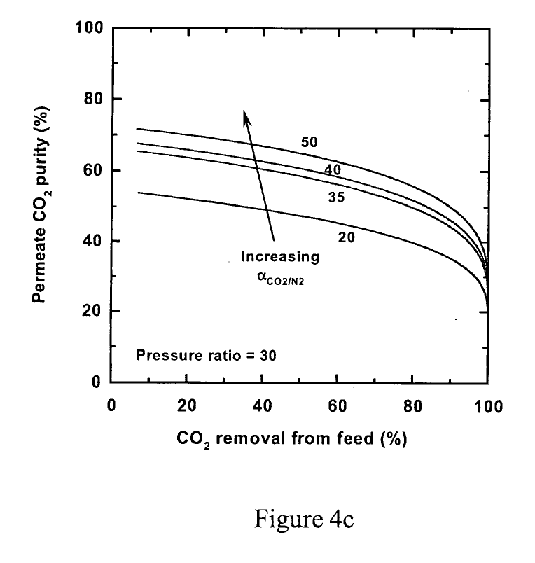

FIGS. 4a-4c illustrate the permeate CO₂ purity throughout the CO₂ removal process at various pressure ratios. In FIGS. 4a-4c, the assumed membrane CO₂ permeance is 1,000 GPU and the flue gas flow handled is 22,654 actual m³/min (800,000 acfm). Increasing the selectivity of the membrane increases the permeate CO₂ purity at each pressure ratio tested. For example, as shown in FIG. 4b, for a pressure ratio of 17, a carbon dioxide/N₂ selectivity of 20 can yield a permeate carbon dioxide concentration in the range of 20-53%, with the lower permeate CO₂ concentrations corresponding to greater fractional carbon dioxide removal from the feed. Improving the selectivity to 50 raises the permeate carbon dioxide concentration to the range of 30-70%. In certain embodiments of the present application, the permeate carbon dioxide purity is high. For example, in some embodiments, the purity is greater than 25%, greater than about 50%, greater than about 75%, or greater than about 90%.

### Example 2

### Effect of Membrane Pressure Ratio and Fractional CO₂ Removal on the Size of Membrane Required for Effective CO₂ Removal

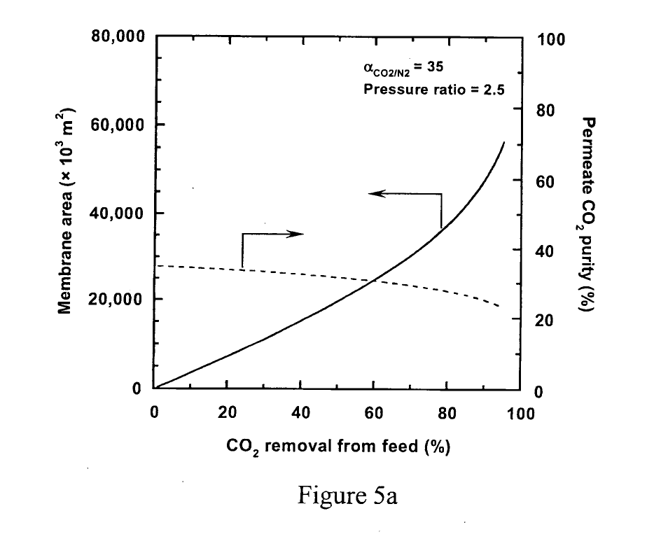

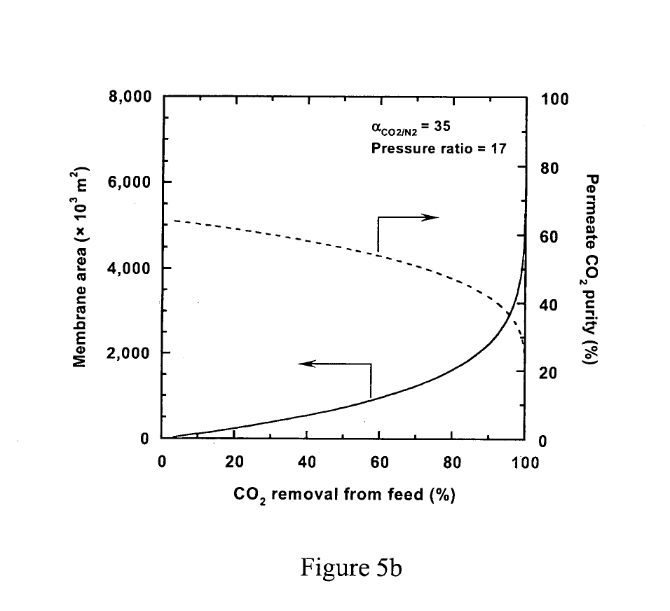

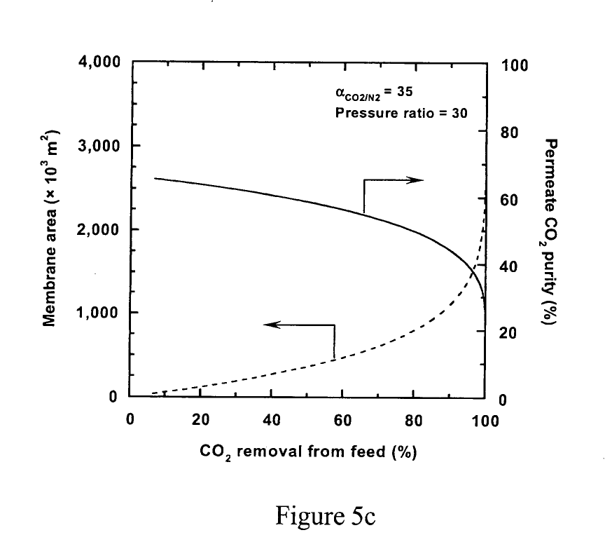

FIG. 5 illustrates the simulated effect of CO₂ removal on required membrane area and permeate CO₂ purity. The assumed membrane properties of the embodiment depicted in FIG. 5 are a CO₂ permeance of 100 GPU, CO₂/N₂ selectivity of 35, and flue gas flow handled of 22,654 actual m³/min (800,000 acfm). For example, in the embodiment depicted by FIG. 5a, for 90% carbon dioxide removal using a membrane with an assumed pressure-normalized CO₂ flux of 100 GPU and CO₂/N₂ selectivity of 35, separation at a low pressure ratio of 2.5 requires 4.8×10⁷ m² of membrane area and yields a permeate with 25% CO₂ purity.

### Example 3

### Effect of Membrane CO₂ Flux and Pressure Ratio on the Size of Membrane Required for Effective CO₂ Removal

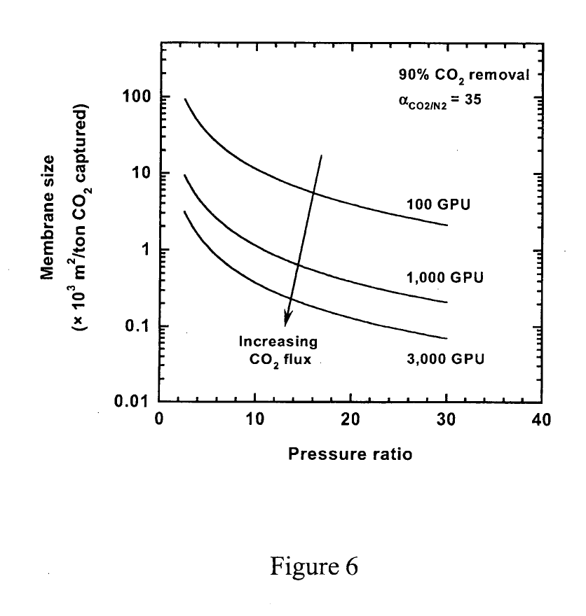

FIG. 6 illustrates how quickly membrane area per ton of CO₂ captured decreases as membrane CO₂ flux and pressure ratio increase. FIG. 6 is based on the assumptions that CO₂/N₂ selectivity of the membrane is 35, carbon dioxide removal is 90%, and gas flow is 22,654 actual m³/min (800,000 acfm). In some embodiments, the pressure ratio may be maximized by use of a compressor. Significant investment in the compressor provides a greater separation driving force, which reduces the membrane area required.

### Example 4

### Process Flow Schematic of an Integrated Membrane-Based and Liquid Solvent-Based System

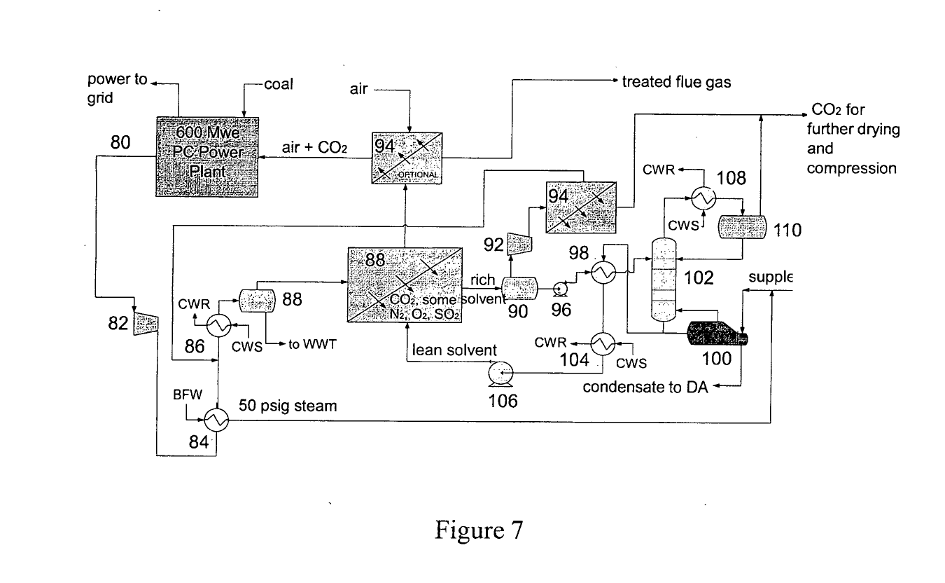

FIG. 7 is a process flow diagram of one exemplary embodiment of the integrated membrane-based and liquid solvent-based system and associated processes. Referring to the embodiment of the present invention depicted in FIG. 7, the flue gas feed stream 80 is compressed to a desired pressure in an adiabatic compressor 82. The hot compressed gas is then sent through two heat exchangers. The first heat exchanger 84 acts as a steam generator that vaporizes the low-pressure boiler feed water to produce 50-psig steam. This steam is sent to the reboiler to partially meet the steam requirement of the CO₂ capture plant. The second heat exchanger 86 acts as trim cooler, where the flue gas exiting the LP steam generator exchanges heat with the cooling water that cools the flue gas down to about 50-60° C. The condensate in the flue gas leaving the trim cooler is removed in a water knock out drum 88. The gas leaving the knock out drum enters the membrane module, where CO₂ selectively diffuses to the permeate side. The solvent enters the permeate side of the membrane 90 in a counter current manner and absorbs the CO₂ present in the permeate (which is more clearly shown in FIG. 2). The absorption in the solvent increases the mass transfer driving force across the membrane, allowing more CO₂ to diffuse through the membrane. Some N₂, O₂, and SO₂ may also diffuse through the membrane. The gas-liquid mixture leaving the permeate-side of the membrane unit is sent to a flash tank 90, where depending on the selected mode of operation, the flash gas is either vented or sent to a membrane unit 92 to further recover CO₂.

If almost all CO₂ in the permeate is absorbed (no CO₂ slip) in the solvent, the flash gas can be mixed with treated gas stream and vented. However, if the solvent is used to absorb CO₂ only partially, the flash gas may contain about 20-40% of CO₂, which can be compressed in compressor 92 and sent to a membrane unit 94, allowing further recovery of CO₂. Since the volume of gas from the flash drum is substantially smaller compared to the total volume of flue gas, the energy required for compression is relatively low. The retentate from the second membrane unit may either be vented or recycled back to the first membrane unit.

The CO₂-rich solvent from the flash tank is taken to a booster pump 96 before passing it through the lean/rich exchanger 98 to recover sensible heat from the hot lean solvent exiting the reboiler 100. The hot CO₂-rich solvent stream is then fed at the top of the solvent regenerator column 102, which could either be a packed column or a trayed column. In the regenerator, CO₂ is released from the solvent by upward flowing steam. The stripping steam in the regenerator is produced by taking a portion of the solvent into the reboiler 100, which vaporizes the water present in the solvent through an indirect contact with low-pressure condensing steam. The low-pressure steam requirement in the reboiler could be met partially by utilizing the steam produced within the capture plant and partially borrowing from the steam turbine. The lean solvent from the bottom of the regenerator is returned back to the membrane module by passing it through the lean/rich exchanger 98, trim cooler 104, and solvent pump 106. The CO₂ stream exiting the top of the regenerator 102 is passed through an overhead condenser 108 and reflux drum 110 and the resulting CO₂ stream is combined with the CO₂ stream from the second membrane unit 94. The combined stream is cooled, dried, compressed to about 150 bar (2,200 prig), and sent to pipeline for sequestration.

The flow sheet shown in FIG. 7 was modeled in Aspen-Plus by integrating a membrane model according to the present invention as a user-defined block. In this preliminary simulation, retentate recycle to increase CO₂ partial pressure in the feed gas was not included. Results from process simulations indicate that a hybrid system capturing 90% CO₂ has an energy penalty of 2.52 MJₜₕ/kg (1,085 Btu/lb) compared to 3.24 MJₜₕ/kg (1,395 Btu/lb) for an aqueous-MEA scrubber system and 3.98 MJₜₕ/kg (1,710 Btu/lb) for a two-stage membrane process. This represents an energy savings of 22% compared to the solvent scrubbing process and 37% compared to the two-stage membrane process.

1. An integrated membrane-based and liquid solvent-based system for selective removal of an acid gas from a gas stream, the system comprising a membrane that is selective for said acid gas and that is structured to have a first surface in contact with the gas stream and a second, opposing surface in contact with a liquid-phase solvent that is selective for said acid gas.

2. The system of claim 1, wherein the system directs flow of the gas stream and flow of the liquid-phase solvent countercurrently.

3. The system of claim 1, wherein the system comprises a gas-liquid-absorption dominant region and a membrane-based gas-permeation dominant region.

4. The system of claim 3, wherein the gas-permeation dominant region comprises the upstream feed inlet end portion of the membrane and the gas-liquid-absorption dominant region comprises the downstream retentate end portion of the membrane.

5. The system of claim 1, wherein the membrane is a non-porous, gas-selective membrane.

6. The system of claim 5, wherein the non-porous, gas selective membrane comprises a dense, selective polymer skin having a thickness of about 10 to about 70 nm, coated on a microporous membrane structure.

7. The system of claim 1, wherein the acid gas is CO₂.

8. The system of claim 7, wherein the membrane has a CO₂/N₂ selectivity of at least about 10.

9. The system of claim 8, wherein the membrane has a CO₂/N₂ selectivity of about 20 to about 30.

10. The system of claim 1, wherein the acid gas is H₂S.

11. The system of claim 1, wherein the solvent has a pH greater than 6.4.

12. A method for removing an acid gas from a gas stream, comprising bringing the gas stream in contact with a first surface of a membrane that is selective for said acid gas, and that has a second, opposing surface in contact with a liquid-phase solvent that is selective for said acid gas, such that the acid gas is removed from the gas stream via both a gas permeation mechanism and a gas-liquid absorption mechanism.

13. The method of claim 12, wherein the acid gas is CO₂.

14. The method of claim 12, wherein the gas-permeation mechanism is dominant at the upstream feed inlet end portion of the membrane and wherein the gas-liquid absorption mechanism is dominant at the downstream retentate end portion of the membrane.
